(19) United States
(12) Patent Application Publication
(10) Pub. No.: US 2023/0314547 A1
(43) Pub. Date: Oct. 5, 2023

(54) LOS, NLOS CHANNEL STATE IDENTIFICATION

(71) Applicant: Fraunhofer-Gesellschaft zur Foerderung der angewandten Forschung e.V., Munich (DE)

(72) Inventors: Mohammad ALAWIEH, Erlangen (DE); Mohammad MOMANI, Erlangen (DE); Ernst EBERLEIN, Erlangen (DE)

(21) Appl. No.: 18/164,452

(22) Filed: Feb. 3, 2023

Related U.S. Application Data
(63) Continuation of application No. PCT/EP2021/071945, filed on Aug. 5, 2021.

(30) Foreign Application Priority Data
Aug. 6, 2020 (EP) 20189874.9

(51) Int. Cl. G01S 5/02; H04W 64/00

(52) U.S. Cl. CPC G01S 5/021; G01S 5/0284; H04W 64/003

(57) ABSTRACT

Transceiver for receiving a receive signal or the plurality of receive signals to be used for position determination over multiple points of time, the transceiver comprising: a measurement unit configured to perform a measurements to detect an information on a first arriving path, advantageously a time or a direction for a first arriving path; and a channel state analyzer configured to estimate a LOS channel condition to determine a channel state information describing the condition of the FAP.

### CROSS-REFERENCE TO RELATED APPLICATIONS

This application is a continuation of copending International Application No. PCT/EP2021/071945, filed Aug. 05, 2021, which is incorporated herein by reference in its entirety, and additionally claims priority from European Application No. EP 20189874.9, filed Aug. 06, 2020, which is also incorporated herein by reference in its entirety.

The present application concerns the field of wireless communication systems and networks, more specifically to a transceiver for receiving a receive signal (plurality of RSs) to be used for position determination and to a corresponding method. Embodiments refer to LOS/NLOS identification with phase measurements.

### BACKGROUND OF THE INVENTION

FIG. 9 is a schematic representation of an example of a terrestrial wireless network 100 including, as is shown in FIG. 9(a), a core network 102 and one or more radio access networks RAN₁, RAN₂, ...RAN_{N}. FIG. 9(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/ LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 9(b) shows an exemplary view of five cells, however, the RANₙ may include more or less such cells, and RANₙ may also include only one base station. FIG. 9(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 9b) shows two loT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 9(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 9(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. All OFDM symbols may be used for DL or UL or only a subset, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 9 may by a heterogeneous network having distinct overlaid networks, e.g., a network of macro cells with each macro cell including a macro base station, like base station gNB₁ to gNB₅, and a network of small cell base stations (not shown in FIG. 9), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 9, for example in accordance with the LTE-Advanced Pro standard or the NR (5G), new radio, standard.

In mobile communication networks, for example in a network like that described above with reference to FIG. 9, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 9. This is referred to as an “in-coverage” scenario. Another scenario is referred to as an “out-of-coverage” scenario. It is noted that “out-of-coverage” does not mean that the two UEs are not within one of the cells depicted in FIG. 9, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 10 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 9. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 11a is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 11a which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 10, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 11b is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 9. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 11c is a schematic representation of a scenario in which two UEs directly communicating with each, wherein the two UEs are connected to different base stations. The first base station gNB1 has a coverage area that is schematically represented by the first circle 200₁, wherein the second station gNB2 has a coverage area that is schematically represented by the second circle 200₂. The UEs directly communicating with each other include a first vehicle 202 and a second vehicle 204, wherein the first vehicle 202 is in the coverage area 200₁ of the first base station gNB1 and connected to the first base station gNB1 via the Uu interface, wherein the second vehicle 204 is in the coverage area 200₂ of the second base station gNB2 and connected to the second base station gNB2 via the Uu interface.

The autonomous resource selection method of NR V2X sidelink transmission mode 2 consists of a sensing and a resource selection phase delimited by corresponding time windows. The resource selection is further split into two steps:
1. Identification of candidate resources within the resource selection window; and
2. Resource selection for initial as well as re-transmission of a transport block (TB) from the identified candidate resources.

Compared to LTE V2X mode 4 the sensing is shorter but still in the order of 100 ms and essentially continuous, i.e., the sensing window is moving. The long sensing duration may cause high power consumption which is a problem for battery-powered UEs. Partial sensing is proposed to address this problem, however, this essentially reduces RSSI and RSRP measurements while in NR the SCI reception and decoding is to be ongoing to cope with aperiodic traffic. In other words, this issue already persisting in LTE V2X mode 4 has not yet been solved in NR V2X mode 2.

Resource selection involves not only the physical but also higher layers. This process could be implemented, for example, as follows:
1. The physical layer provides the sensing results to the upper layer;
2. The higher layer selects the resource for the initial transmission carrying the reservation(s);
3. The higher layer signals the selected radio time resources to the physical layer;
4. The physical layer receives the selection parameters of resources from the higher layer to reserve them;
5. Possibly, it receives a small TB from the higher layer, if the PSSCH shall be used for an initial transmission. Note that a reservation directly after resource selection is an initial transmission;
6. Preparation, formatting and transmission of the PSCCH and PSSCH on the selected resources.

Especially, the involvement of higher layers and signaling between the layers cause longer latency that not only delays the delivery of packets but also increases the risk of collisions since the sensing information becomes more outdated the longer the gap between sensing and transmission is. For example in [2] minimum desired values are stated for the processing times T_{proc,0} (time between the end of sensing window and resource selection trigger) and T_{proc,1} (maximum time between (re)selection trigger and start of selection window) with 0.5 ms and 1 ms, respectively. Depending on the numerology, 15, 30, 60 or 120 KHz the sum of these values of 1.5 ms together with additional time needed for slots alignment causes a latency between the last sensing slot and transmission of at least 3, 4, 7 or 13 slots, respectively. Since any transmission of a reservation of another UE during that time cannot be recognized in time, even if sensing is continued in the gap, a collision cannot be avoided if these reservations are overlapping, unless it is sufficiently far in the future that a pre-emption is possible.

Due to non-periodic traffic in NR V2X, the prediction of the behavior of other UEs is not possible. Though the resource reservation agreed for NR V2X mode 2 can indeed reduce the collision probability, however, the latency between sensing and resource selection yields more sensing results that are outdated which in turn increases the collision probability again, as explained above.

A known solution is specified on 3GPP RAN1. The corresponding options are described in the first proposal in section 7.2.4.2.2 of [1]. The final stage of 5G V2X in release 16, as specified in [3] chapter 16 and [4] chapter 8, is denoted as known in the following.

A correlation receiver normally identifies the first arriving path (FAP) and derives based on the FAP the measurements needed for determining a UE position (example Time of Arrival ToA measurements derived on the time the FAP is detected). FIG. 1 shows the correlation output at measurement unit achieved by a applying a correlation filter correlating a reference signal with the received signal. The measurement unit cannot detect based on the correlation profile if the first arriving path, indicated by FAP, is a LOS or NLOS state.

For 5G positioning several positioning methods are supported:
TDOA (time difference of arrival)
   ◯ OTDOA (observed time difference of arrival at the measurement device)
   ◯ UTDOA (uplink time difference of arrival)
Multi-RTT (round trip time)
AoA (Angle of Arrival)
DoA (Direction of Arrival)

The accuracy of all these methods rely on LOS or NLOS condition. If the measurement device does not provides additional information beyond the timing, power or direction measurement the position calculation unit will not be able to identify the potential error and extract faulty measurement or determine the measurement quality. Therefore, there is the need for an improved approach.

### SUMMARY

According to an embodiment, a transceiver for receiving a receive signal or a plurality of receive signals to be used for position determination over multiple points of time may have: a measurement unit configured to perform a measurements to detect an information on a first arriving path, the information includes a time or a direction for the first arriving path; and a channel state analyzer configured to estimate a LOS channel condition to determine a channel state information describing the condition of the first arriving path.

According to another embodiment, a communication system may have at least a user equipment and a TRPTRP or at least two user equipments having an inventive transceiver.

According to another embodiment, a method for signaling the LOS channel condition within an inventive communication system may have the steps of (DL Procedure): NW checks UE capability for phase processing or channel state detection; Configure the UE to receive one or more PRS resource for phase processing or channel state detection; Provide UE with the PRS configuration and/or indicate resources to process coherently; UE process the PRS resources and/or report the phase measurements for multiple snapshots or the Movement information w.r.t. the PRS measurements or a LOS/NLOS/OLOS condition based on the PRS measurements within a TRP resource set.

According to another embodiment, a method for signaling the LOS channel condition within an inventive communication system may have the steps of (UL Procedure): NW checks UE capability for phase transmission; Configure the UE with SRS for phase tracking configuration; Indicate to the UE that SRS resource is configured for coherent processing; UE report the movement information w.r.t. the measurements and/or TRP process the SRS resources and/or Report the phase measurements to the LMF and/or report a LOS/NLOS/OLOS condition based on the SRS measurements within a SRS resource set and/or LMF detects the LOS/NLOS condition.

According to another embodiment, a method for signaling the LOS channel condition within an inventive communication system may have the steps of (DL- UL Procedure (RTT)): NW checks UE capability for coherent SRS resource transmission; NW checks UE capability for phase processing or channel state detection; Configure the UE with SRS for phase tracking configuration; Indicate to the UE that SRS resource is configured for coherent processing; Configure the UE to receive one or more PRS resource for phase processing or channel state detection; Provide UE with the PRS configuration and indicate resources to process coherently; UE report the Movement information w.r.t. the measurements and/or UE process the PRS resources and/or Report the phase measurements for multiple snapshots and/or Report the Movement information w.r.t. the PRS measurements and/or Report a LOS/NLOS/OLOS condition based on the PRS measurements within a TRP resource set and/or TRP process the SRS resources and/or Report the phase measurements to the LMF and/or Report a LOS/NLOS/OLOS condition based on the SRS measurements within a SRS resource set and/or LMF detects the LOS/NLOS condition.

According to another embodiment, a method for signaling the LOS channel condition within an inventive communication system may have the steps of (Sidelink Procedure (RTT)): NW checks UE(s) capability for coherent sidelink-PRS resource transmission; NW checks UE(s) capability for phase processing or channel state detection; Configure the UE (or UEs) with sidelink-PRS for phase tracking configuration; Indicate to the UE that sidelink-PRS resource is configured for coherent processing; Configure the UE to receive one or more sidelink-PRS resource for phase processing or channel state detection; Provide UE with the sidelink-PRS configuration and indicate resources to processed coherently; One or multiple UEs reports the Movement information w.r.t. the measurements and/or UE process the sidelink-PRS resources and/or Report the phase measurements for multiple snapshots and/or Report the Movement information w.r.t. the PRS measurements and/or report a LOS/NLOS/OLOS condition based on the sidelink-PRS measurements within a second UE and/or LMF detects the LOS/NLOS condition.

According to another embodiment, a method for performing a channel state analysis may have the steps of: receiving a receive signal or the plurality of receive signals to be used for position determination over multiple points of time; performing a measurements to detect an information on a first arriving path, advantageously a time or a direction for a first arriving path; and estimating a LOS channel condition to determine a channel state information describing the condition of the FAP.

Another embodiment may have a non-transitory digital storage medium having a computer program stored thereon to perform the method for performing a channel state analysis having the steps of: receiving a receive signal or the plurality of receive signals to be used for position determination over multiple points of time; performing a measurements to detect an information on a first arriving path, advantageously a time or a direction for a first arriving path; and estimating a LOS channel condition to determine a channel state information describing the condition of the FAP, when said computer program is run by a computer.

Another embodiment may have a transceiver configured to receive a receive signal and having a position/motion detection entity configured to determine a position/motion of the transceiver or a position/motion of another transceiver, wherein the position/motion detection entity uses for the determination of the position/motion a channel state information classifying the receive signal as LOS state, NLOS state, OLOS state, or MPC state.

According to another embdodiment, a communication system may have at least a user equipment and a TRP or at least two user equipments having an above-mentioned transceiver.

According to another embodiment, a method for position/motion detection may have the steps of: receiving a receive signal and for a position/motion detection entity; determining a position/motion of the transceiver or a position/motion of another transceiver by use of a channel state information classifying the receive signal as LOS state, NLOS state, OLOS state, or MPC state.

Another embodiment may have a non-transitory digital storage medium having a computer program stored thereon to perform the method for position/motion detection, the method having the steps of: receiving a receive signal and for a position/motion detection entity; determining a position/motion of the transceiver or a position/motion of another transceiver by use of a channel state information classifying the receive signal as LOS state, NLOS state, OLOS state, or MPC state, when said computer program is run by a computer.

Embodiments provide a transceiver for receiving a receive signal (plurality of RSs) to be used for position determination over multiple points of time, the transceiver comprising a measurement unit and a channel state analyzer. The measurement unit is configured to perform a measurements to detect an information on a first arriving path (FAP), advantageously a time or a direction for a first arriving path (FAP). The channel state analyzer is configured to estimate a LOS channel condition to determine a channel state information describing the condition of the FAP.

According to embodiments, the channel state analyzer may be configured to analyze a correlation profile of the receive signal (plurality of RSs), wherein the analyzing comprises:
extraction of a first information for the correlation profile at a first point of time; and
extraction of a second information for the correlation profile at a second point of time; and
extraction of a third information for the correlation profile at a third point of time;
wherein the channel state analyzer is configured to determine the channel state information based on a relationship of the first, second and third information with respect to each other.

According to embodiments, the receive signal (plurality of RSs) comprises multiple frames or is a periodic signal or a semi-persistent signal or a signal with a known time offset; additionally or alternatively the channel state analyzer may be configured to perform the evaluation for further points of time.

According to embodiments, the multi-points of time are defined by at least one out of the group comprising the following:
a slot number
$${n}_{\text{s,f}}^{μ}$$
of a radio frame,
a OFDM symbol number l, wherein l = 0 corresponds to the first OFDM symbol of the SRS or PRS transmission,
a OFDM symbol index l′ of the slot that corresponds to the first OFDM symbol of the SRS transmission in the given slot.

According to embodiments, the receive signal (plurality of RSs) is received along a movement of the transceiver for receiving the receive signal (plurality of RSs) over the first, second and third point of time or along a movement of a transmitter outputting the receive signal (plurality of RSs) over the first, second and third point of time.

According to embodiments, the channel state analyzer may be configured to classify the receive signal (plurality of RSs) as LOS state, NLOS state or to classify the receive signal (plurality of RSs) as LOS state, NLOS state, OLOS state; and/or to classify the receive signal (plurality of RSs) as LOS state, NLOS state or MPC state.

According to embodiments, the information to be extracted refers to at least one of the group comprising:
magnitude of the FAP peak;
width of a correlation lobe (near refractions causes the lobe to get wider and hence, effect the TOA quality);
overall channel information (RSPR, k-factor);
jitter of the FAP (time) position by comparing the expected TOA based on known resource configuration with the measured TOA;
phase information on multiple points of time (multiple time instances).

According to embodiments, the channel state analyzer may be configured to perform a phase measurement of the receive signal (plurality of RSs) received at the first point of time, second point of time and third point of time in order to extract the first, second and third information.

According to embodiments, the channel state analyzer is configured to perform a phase measurement to determine an angle of departure of a transmission signal and/or to determine an angle of arrival of the receive signal.

According to embodiments, a proportional course of a phase of the receive signal (plurality of RSs) over the first, second and third point of time may indicate to an LOS state; a discontinuous course of the phase of the receive signal (plurality of RSs) over the first, second and third point of time may indicate an NLOS state; wherein a combination of a proportional course and a discontinuous course of a phase of the receive signal (plurality of RSs) over the first, second and third point of time may indicate an OLOS state.

According to embodiments, the channel state analyzer is configured to account the phase measurement with directional information derived from the Angle of Arrival and/or Angle of Departure and/or antenna beam characteristics.

According to embodiments, the phase measurements can comprise either one or a combination of the phase measurements on different time intervals, phase measurements at different frequencies or bandwidth parts, or phase measurements between different transmitter units or phase measurements between different receiver units or phase measurements between the different antenna ports of the same transmitter or receiver units.

According to embodiments, the channel state analyzer is configured to detect a first arriving path and/ a time-position of the first arriving path at a first, second and third point of time.

According to embodiments, the transceiver comprises a position determination entity configured to determine a position information based on an information regarding the first arriving path of the receive signal (plurality of RSs) taking into account the channel state information.

According to embodiments, the transceiver comprises a reporting entity configured to output a report on the channel state information to a second transceiver; alternatively, the transceiver comprises a transmitter configured to output a report on the channel state information to a network entity (LMF) and wherein the report comprises an information out of the following:
channel state (LOS, NLOS, OLOS);
confidence information (an integer providing an indication of the confidence of the provided channel state information)
quality information (an integer providing an indication of the quality of the FAP of the receive signal (plurality of RSs);
second channel state;
second channel confidence information (second quality information);
occurrence (providing the percentage that a channel state occurred over a period of time;
LoS/NLoS indicator(s) for DL, UL, and/or DL+UL positioning measurements (taken at both UE and TRP at least for UE assisted positioning).

This means according to embodiments, that a support reporting (e.g. to the LMF) is enabled. The reporting may include LoS/NLoS indicators for DL, UL, and DL+UL positioning measurements taken at both UE and TRP at least for UE assisted positioning.

According to embodiments, one of the following options (or combinations of the following options) for LoS/NLoS indicators may be supported:
o Option 1: Binary (i.e., hard) value indicators
o Option 2: Soft value indicators (i.e., [0,1])

According to embodiments, the channel state analyzer is configured to analyze the receive signal (plurality of RSs) with regard to a confidence of the channel state and/or with regard to a quality of the receive signal (plurality of RSs) ; a high amplitude and/or a sharp lobe may indicate a high quality of the receive signal (plurality of RSs) ; a low amount of information for the correlation profile out of a general trend of all information for the correlation profile may indicate a high confidence of the channel state.

According to embodiments, the channel state information is used for the measuring out of the group:
RSTD for DL=TDOA and OTDOA;
RTT for multi-RTT;
RTOA of UTDOA;
DOA or AOA for directional based methods.

According to embodiments, the reporting entity is configured by a higher layer (RRC, LPP, NLPPA or DCI) to report a channel state.

According to embodiments, the channel state analyzer is configured to be externally triggered, wherein the triggering comprises an exchange of the following information:
informing on capability for using channel state; and/or
requesting measurements of a channel state; and/or
configuring a transceiver to use the same Tx spatial filter during coherent processing.

According to embodiments, the channel state analyzer is configured to conFig. the transmitter transmitting the receive signal with two or more resources with different configurations, where the configurations are out the group comprising:
at least a bandwidth configuration (e.g. high bandwidth in combination with low periodicity);
a period configuration (e.g. high periodicity in combination with low bandwidth)
slot/offset and using both resource
to determine a LOS condition.

According to embodiments, the channel state analyzer is configured to configure the transmitter transmitting the receive signal with two or more resources and indicating which resources may be coherently processed; additionally or alternatively the channel state analyzer is configured to configure the transmitter transmitting the receive signal comprising multiple signals or to receive the receive signal comprising multiple signals for a channel state detection mode with the same spatial domain transmission filter.

According to embodiments, the channel state analyzer is configured to trigger a transmission of a receive signal (plurality of RSs) comprising at least two coherent signals (coherent bands).

According to embodiments, the transceiver comprises a position / motion detection entity.

According to embodiments, the position/motion detection entity is configured to determine a motion of the transceiver and/or a direction of the motion of the transceiver using an internal sensor, advantageosuly an IMU sensor. In accordance with an embodiment, the position/motion detection is derived at least on one of the following reference signals :
DL-PRS
UL-SRS
SL-PRS
CSI-RS
SSB.

Note the one or more recive signals as discussed above can be used as reference signal. This means that the receive signal forms according to embodiments a reference signal.

According to embodiments, the position/motion detection entity is configured to determine the motion and/or direction upon LMF requests; alternatively or additionally the LMF triggers the transceiver to report the motion / direction information to a given time interval in relation to a transmitted SRS or a received PRS; alternatively or additionally the motion and/or direction information comprises a displacement information Δd.

According to embodiments, the position/motion detection energy is configured to determine a position at a first point of time and at a second point of time and to calculate the displacement Δd based on the equation Δd = c (τ_{B} - τ_{A}) = cΔ_{τ}.

According to embodiments, wherein the channel state analyzer analyzes the channel state based on the formula using

$$\text{Δ} φ \text{=} \frac{2 π \text{Δ} d}{λ} + ε ,$$

wherein ε is a random error.

According to embodiments, wherein the position/motion detection entity is configured to use MPC, in case of NLOS state (as virtual TRP from the point of view of the UE).

Another embodiment provides method for performing a channel state analysis comprising the steps:
receiving a receive signal (plurality of RSs) to be used for position determination over multiple points of time;
performing a measurements to detect an information on a first arriving path (FAP), advantageously a time or a direction for a first arriving path (FAP); and
estimating a LOS channel condition to determine a channel state information describing the condition of the FAP.

Note, the estimating may comprise an analyzing a correlation profile of a receive signal (plurality of RSs) to be used for a position determination over multiple points of time, comprising the sub steps of
extraction of a first information for the correlation profile at a first point of time; and
extraction of a second information for the correlation profile at a second point of time; and
extraction of a third information for the correlation profile at a third point of time; and
determining a channel state information describing the conditions of the receipt of the receive signal (plurality of RSs) based on a relation of the first, second and third information with respect to each other.

Another embodiment provides a computer program having a program code for performing, when running on a computer, the above method.

Another embodiment provides a Transceiver configured to receive a receive signal and comprising a position/motion detection entity configured to determine a position/motion of the transceiver or a position/motion of another transceiver, wherein the position/motion detection entity uses for the determination of the position/motion a channel state information classifying the receive signal as LOS state, NLOS state, OLOS state, or MPC state.

According to embodiments, a user equipment (downlink measurements) comprises the above transceiver. According to embodiments, a TRP (uplink measurements) comprises the above transceiver. According to embodiments, a reference device (uplink and/or downlink measurements) comprises the above transceiver. According to embodiments, a user equipment (sidelink measurements) communicating with another user equipment comprises the above transceiver.

Another embodiment provides a communication system comprising at least a user equipment and a TRP or at least two user equipments as defined before. Here, one of the entities may transmit the receive signal (plurality of RSs).

Another embodiment provides method for position/motion detection, comprising:
receiving a receive signal and for a position/motion detection entity;
determining a position/motion of the transceiver or a position/motion of another transceiver by use of a channel state information classifying the receive signal as LOS state, NLOS state, OLOS state, or MPC state.

According to embodiments, the channel analyzer is configured to determine the LOS or NLOS channel state condition from a complex correlation at a measurement instant based on the following method (performed by the channel analyzer), the method comprising:
Detecting a time of arrival for the first arriving path within the measurement instant; and
Extracting at least three samples from the complex correlation values depending on the detected first arriving path; and
Evaluate the characteristics of the complex plane cross correlation in complex plane; and
Depending on the evaluation, estimate a LOS, OLOS or NLOS channel state for the FAP.

According to embodiments, the evaluation can represent a complex correlation area; additionally or alternatively, the evaluation represent a difference between a reference complex correlation and a reference complex correlation; Note, the FAP from a NLOS tends to vary rapidly due behavior of the multipath with from large and changing relfection surfaces. The complex correlation channel analyzer can evaluate the complex correlation characteristics at multiple time instants from multiple measurements and estimate the LOS, NLOS, or LOS state from the multiple measurements. According to embodiments, the evaluation on the more evaluation at multiple time instants.

Another embodiment provides a corresponding computer program having a program code for performing, when running on a computer, said method.

### BRIEF DESCRIPTION OF THE DRAWINGS

Embodiments of the present invention will be detailed subsequently referring to the appended drawings, in which:

FIG. 1 illustrates absolute value for a correlation output;

FIG. 2 shows an example scenario: TRP as Tx at coordinates (-50,10) and the UE as Rx moving on a 10 m track from (-27,-4) to (-37,-4) for illustrating embodiments;

FIG. 3 shows a complex correlation profile first arriving path for illustrating embodiments;

FIG. 4 shows schematically unwrapped phase for LOS and NLOS links for illustrating embodiments;

FIGS. 5A-5B show schematic block diagrams for illustrating the usage of displacement and orientation information to identify a channel state according to embodiments, wherein 5A illustrates track and LOS reception and 5B virtual TRP positon from NLOS reception;

FIG. 6 shows a “Track″ Δd derived from Δd = d cosθ, Red″LOS” Δd derived from

$$\text{Δ} d = λ \frac{\text{Δ} φ}{2 π}$$

to illustrate embodiments;

FIG. 7 shows a block diagram illustrating an OLOS situation according to embodiments;

FIG. 8 illustrates four diagrams of measurements from 4 Antennas looking in different direction for LOS and NLOS at different snapshots on the Track (X-axis Samples (time); Y-axis: Normailzed Correlation) to discuss embodiments;

FIGS. 9A-9B illustrate schematic representations of an example of a terrestrial wireless network including a core network and one or more radio access networks, and of an example of a radio access network that may include one or more base stations ;

FIG. 10 illustrates a schematic representation of an in-coverage scenario in which two UEs directly communicating with each other are both connected to a base station;

FIGS. 11A-11C illustrate schematic representations of scenarios of UEs communicating with each other;

FIG. 12 illustrates an example of a computer system; and

FIG. 13 shows a schematic representation of a transceiver according to embodiments.

### DETAILED DESCRIPTION OF THE INVENTION

Before discussingsummar the invention, conventional technology will be discussed, where the recognition of drawbacks is part of the invention.

For LTE the accuracy requirements where below 50 meters. The channel state between the UE and Base station was for most of the deployment scenarios was in NLOS condition. With 5G, positioning was introduced in Release 16 targetting much higher accuracy levels (<20 cm). However supporting a channel state identification in 3GPP is not supported up to yet.

The current standard does not enable a mechanism for configuring an entity to perform or report complex-values (real-lm) for the correlation information.

### LOS/NLOS Detection Approach

The current standard does not enable a mechanism for configuring an entity to perform or report complex-values (real-lm) for the correlation information.

According to embodiments, it is possible to determine LOS/NLOS reception based on the phase measurements

Bellow, a possible definition of LOS, NLOS and OLOS in addition to the multipath will be given.
◯ LOS, NLOS and OLOS reception: Physical objects along the signal propagation path such as buildings or movable objects can either block the LOS propagation or cause that of the propagating transmitted signal to be reflected.
◯ NLOS: direct LOS propagation is blocked or strongly attenuated and the link between the transmitting and receiving antenna results from one or more multipath components (MPCs). For positioning applications, NLOS reception adds a bias on the estimated time of arrival or results in a faulty direction estimation.
◯ LOS: direct LOS propagation is received in the link between the transmitting and receiving antenna additional MPCs adds to the LOS path. If the reflected MPCs arrive at the receiving antenna coincident with the LOS path this could result in an increase or a decrease in the received signal level resulting from the sum of the phase and amplitude of the MPCs and the LOS path.
o OLOS (obstructed LOS): similar to NLOS in terms that direct LOS propagation is blocked or strongly attenuated and the link between the transmitting and receiving antenna results from one or more multipath components (MPCs). However the MPCs are a result of diffraction from for example an edge obstacle (industry cabinets).

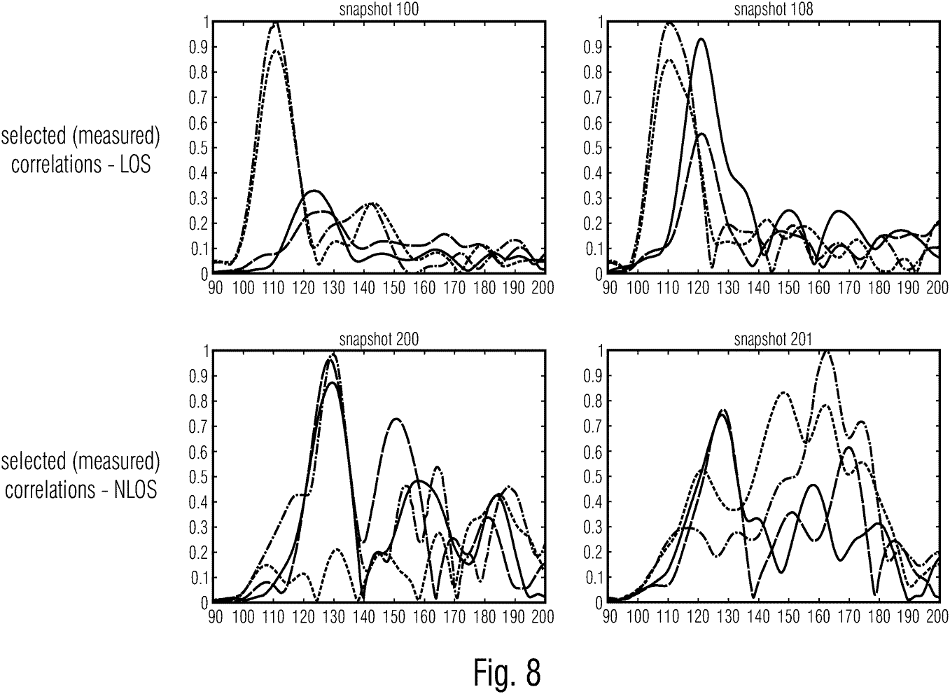

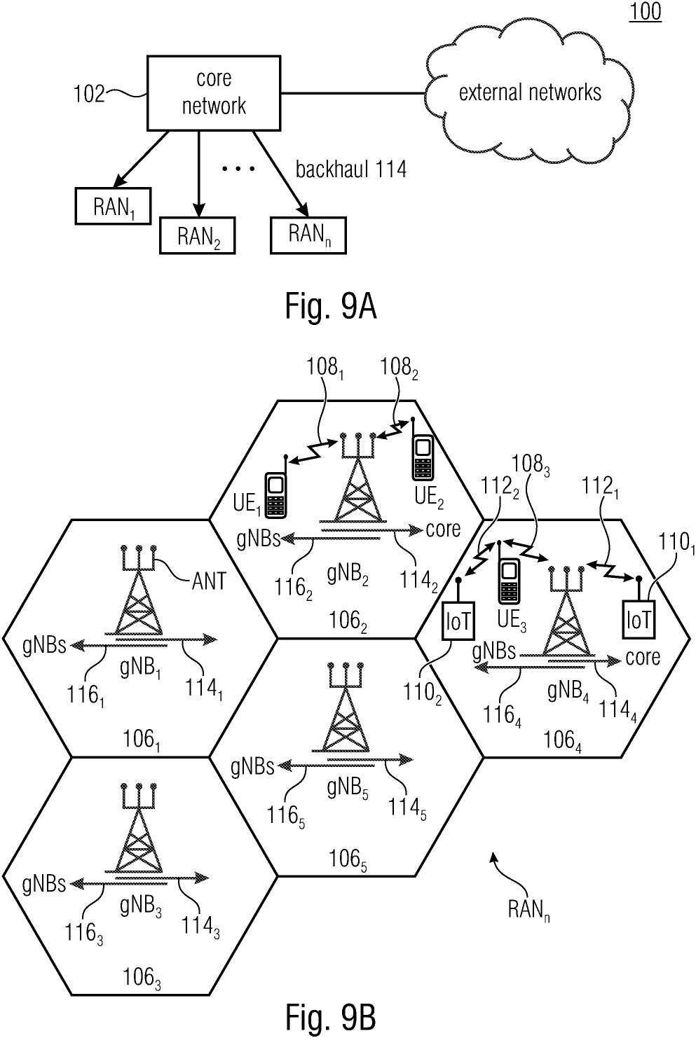

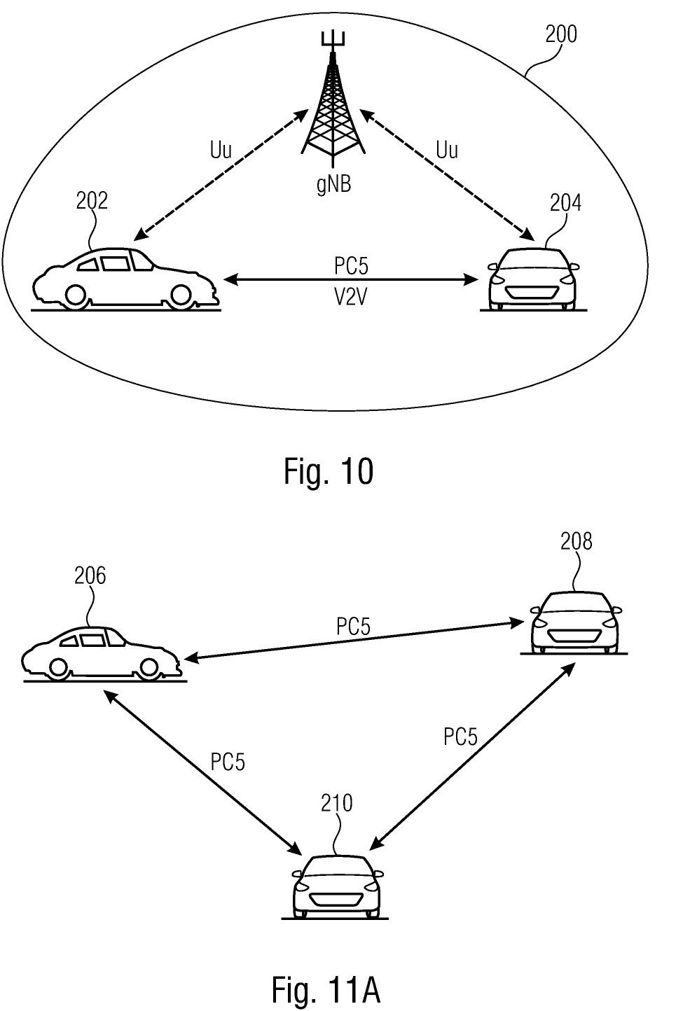

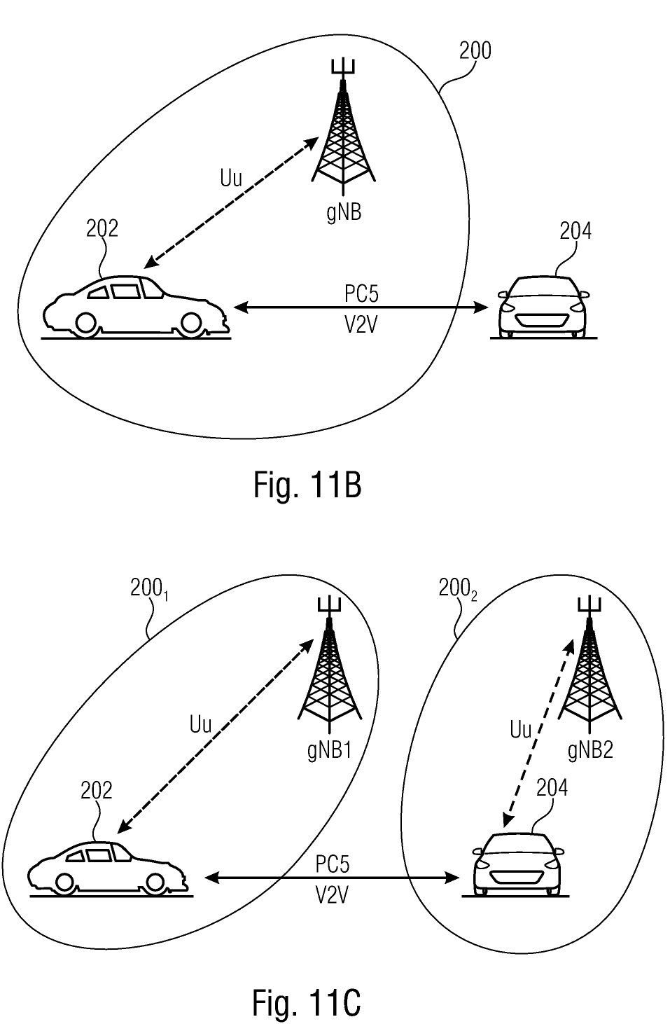

FIG. 8, illustrates a comparison between LOS and NLOS. Here signals received by different points of time are illustrated by differently colored curves. As can be seen the NLOS signals over the different points of time are unstable when compared to the LOS signals.

### Multipath Types:

The multipath components in a LOS, OLOS or NLOS can be seen as result of either one or a combination of more than one of the following:
◯ Large Surface reflections (example NLOS clusters, ground reflections): Reflections from surfaces with a relatively large reflecting area causes highly correlated and varying changes on the complex CIR due to the constructive and destructive addition of the MPCs. Multiple bounces from narrow surface reflections can also be assumed as large surface.
◯ Impact: cause fluctuations on the direct path and other reflected paths

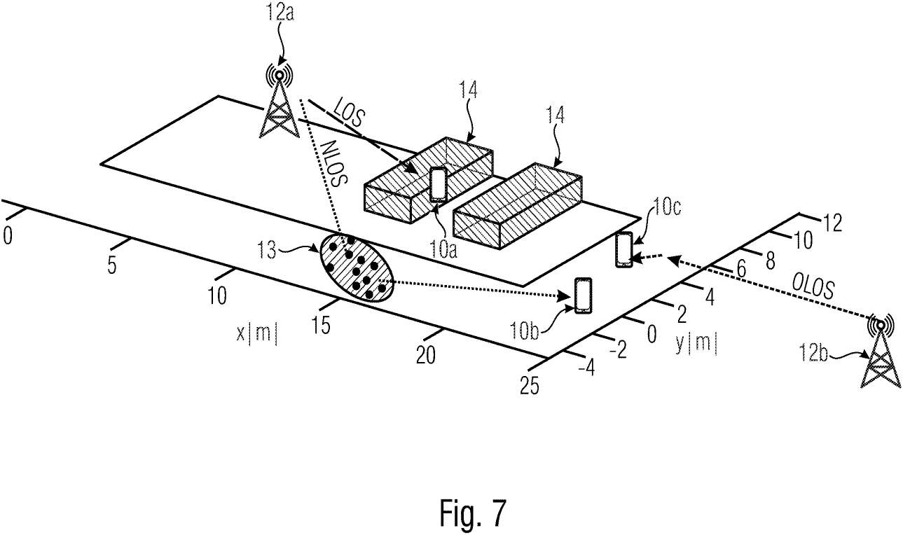

Narrow Surface reflections will be discussed with respect to FIG. 7. FIG. 7 shows three UEs 10a, 10b and 10c receiving signals from transmission point 12a and/or transmission point 12b. The UE 10a has a height position, such that same can receive a receive signal from a transmission point 12a via an LOS. This was true even if the UE 10a is between the two obstacles 14, but high enough to receive the signal from 12a. The UE 10b is in a position receiving an NLOS signal from the transmission point 12a, since the direct LOS is disturbed by the obstacles 14. For the UE 10b the receive signal is received as being transmitted from a virtual transmit point 13. The height position of the UE 10c is the same, wherein the position is directly behind the obstacles 14, such that 10c receives a signal of the transmission point 12b, namely the OLOS.

Reflection from edges or diffraction (knife edge obstacle), OLOS (obstructed LOS, cf. FIG. 7) is used to describe this impact:
o Impact: causes rapid varying channel characteristic with UE movement.

Similar channel characteristics (RMS Delay Spread and Shadow Fading) Based on the above, the channel characterization enables the responsible entity to classify a Tx-Rx link as LOS, NLOS or OLOS. The MPC types gives an additional indication on the classified quality and uncertainty as well.

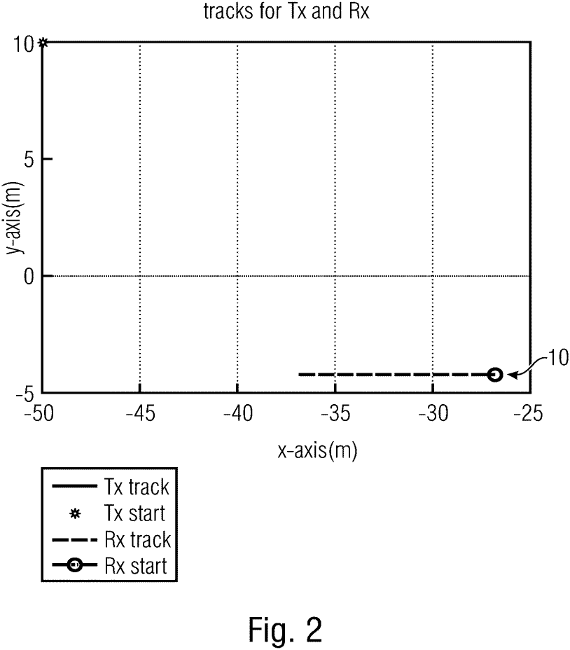

An example is illustrated by FIG. 2 showing a scenario: a UE 10 moving on track, acting as an Rx, is receiving a downlink (DL) signal, for example PRS, transmitted from a fixed Transmission Reception Point (TRP). The PRS resource can be configured as a periodic or semi-persistent with known configurations to the UE. The UE can analyzes the correlation profile for the correlation lobe corresponding to the FAP for the different times (in this case corresponding to a new position on the track) based on the following steps:
o Detecting a first arriving path on more than more one time instant
o Derive information related to the FAP using one or more of the following
   1 . The magnitude of the FAP peak
   2. The width of the correlation lobe (near reflections causes the lobe to get wider and hence effect the TOA quality)
   3. Overall channel information(RSRP, K-factor)
   4. The jitter of the FAP position by comparing the expected TOA based on known resource configuration with the measured TOA
   5. Using the phase information on multiple time instances

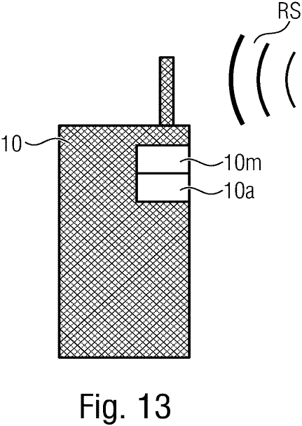

A UE 10, as it is illustrated by FIG. 13, can perform a position determination over multiple points of time as follows. The transceiver 10 receives one or a plurality of receive signals RS and performs a measurement on the one or more receive signals RS to detect a first arrival path FAP. This procedure is performed by the measurement unit 10m of the transceiver 10. The information to be determined may, for example, be a time or a direction for the first arrival path FAP. As discussed above, it may be beneficial to have additional information on the first arrival path FAP, e.g. regarding the LOS channel condition. This information is determined using the channel state analyzer 10a which is configured to estimate an LOS channel condition to determine a channel state information describing the condition of the first arrival path FAP.

For example, a correlation profile of the receive signal or the plurality of receive signals (RSs) may be used. According to an embodiment, the analyzer 10a performs the analysis by attracting a first information for the correlation profile at a first point of time, a second information for the correlation profile at a second point of time and a third information for the correlation profile at a third point of time. The channel state information is then determined based on the relationship of the first, second and third information with respect to each other.

The processing entity 10a responsible for the classification can use one or more of the information to determine the FAP LOS condition. The processing entity can apply machine learning approach based on this input information.

According to embodiments, reporting channel state information can be performed: Based on this information derived the UE (as a measurement entity) can either report the measurements to a second entity (for LMF) or the UE can use this information to determine a LOS/OLOS/NLOS reception.

For this case the UE (or/and TRP) reports the LMF the channel state:
o Channel state: LOS, NLOS, OLOS
o Confidence (optional): is an integer providing an indication of the confidence in the provided channel state
o Quality(optional): is an integer providing an indication of the quality of the FAP
o Secondary channel state (optional): LOS, NLOS, OLOS
o Secondary channel confidence (optional): is an integer providing an indication of the confidence in the Secondary channel state
o Occurrence (optional): provides the percentage that a channel state occurred over a period of time. This field is present for the case the channel state is not reported per measurement (i.e. reported for multiple measurements).

The reporting entity can associate the channel state reporting with the links used for the measurement performed for example RSTD for DL-TDOA and OTDOA, RTT for multi-RTT, RTOA of UTDOA, and DOA or AOA for directional based methods. The reporting provides the positioning entity (LMF) the channel state information with time information: systemFrameNumber and HyperSFN as defined in TS 36.331 and TS 38.331.

For TDOA measurement reporting like RSTD (involving two-TRP links per measurement), the reported channel state indicates the channel state for one link where the reporting entity can be configured to report the reference link separately. To reduce signaling overhead, the reporting entity can be configured by higher layers (RRC [2], LPP [1], MAC-CE) to configure a UE to report a change in state or NRPPa [3] to configure a TRP. In this case the reporting entity reports the channel state once the LOS/NLOS/OLOS changes. The configuration message provides the reporting entity with instruction on the reporting which can optionally configure triggering the Occurrence field.

Below a definition of the measurement and reporting entity will be given: For a downlink scenario the UE receives the RS signal transmitted from one or more TRPs and performs the measurements and is hence the measurement entity. For an Uplink scenario the TRP receives the RS signal transmitted from the UE and performs the measurements and is hence the measurement entity. For an Uplink-Downlink scenario both the UE and TRP are the measurement units. For sidelink, one or two communication UEs are the measurement units.

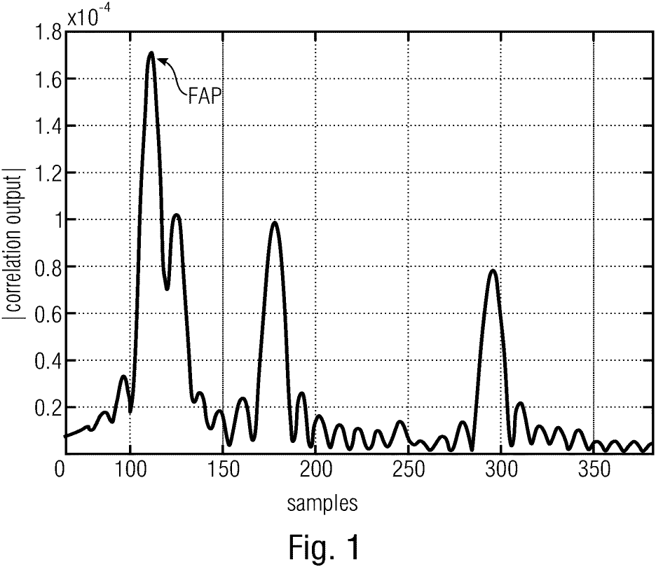

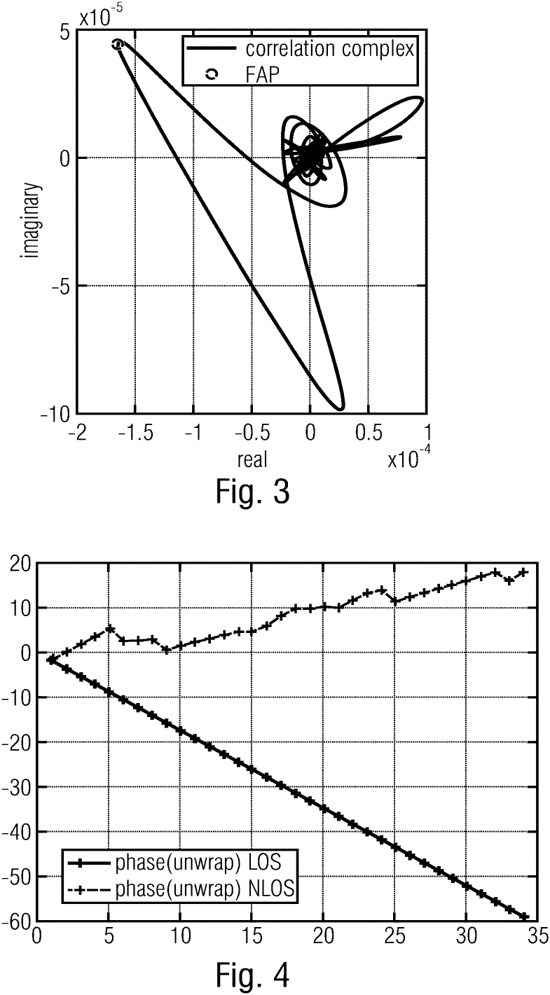

According to embodiments, it is possible to determine the complex valued FAP. For the same measurement from FIG. 1, FIG. 3 shows the complex correlation output and the position of the FAP. The four peaks in FIG. 1, including the FAP peak and the later multipath components are also be seen provided by the complex correlation profile in FIG. 3. According to embodiments, the evaluation can represent a complex correlation area, as illustrated by FIG. 3.

Classical methods analyze the correlation profile of the correlation magnitude in the time plane. A receiver receives multiple reflections from the same transmitted signal with different propagation times. For frequency band limited signals, the near reflection around the first arrival path might result in variations in amplitude and phase which depends on the power of each path and reception time. The complex correlation and contains additional phase information needed to estimate a channel state condition. Such information is lost when considering the correlation magnitude alone.

Thus, according to further embodiments, the receiver/measurement unit is configured to analyze a correlation profile and/or complex correlation profile with respect to an amplitude and/or a phase.

According to embodiments, phase measurements can be used to detect a LOS/NLOS condition. The measurement entity can perform successive phase measurements on the FAP path on the RSs transmitted on multiple time or frequency instants. The measurement entity can make a hypothesis whether the link corresponds to a channel state (NLOS, OLOS or LOS) by comparing the behavior of the measurements and the expectation of each of the channel state.

For the same example scenario, FIG. 4 shows the unwrapped phase measurements vs the snapshots on x-axis (time instants where the measurements are applied). A LOS channel and a NLOS channel for the same scenario is applied (i.e. the UE track and TRP position are the same and applying one time a LOS channel and NLOS for the second). Phase unwrapping ensures that all appropriate multiples of 2π have been included to the phase response. Knowing the characteristics of a NLOS channel, the measurement can identify a NLOS with a high certainty when taking multiple measurements (more than 5 in this example. The measurement entity can use the consistency of the phase measurements to derive this information. Clearly for a LOS reception the phase measurements are consistent and are proportional to relative distance between the UE and the TRP(s).

Signaling 3GPP:To enable the procedure related to phase processing
[Measurement entity: UE/TRP] Inform the measurement entity that a DL PRS or an UL SRS resource is configured for phase processing or LOS detection or coherent processing
[UE capability] Request a UE capability for performing one or more for:
   o Phase measurements
   o Channel state determination
   o SRS coherent resource transmission
[Transmitter-UE: configuring the UE to use the same Tx spatial filter during coherent processing]

When the UE is configured by the higher layer parameter SRS-for-Positioning or SRS and if the higher layer parameter within a resource or resource set indicates phase or coherent configuration: then the UE shall transmit the target SRS resource with the same spatial domain transmission filter over the configured resource.
◯ Higher layer parameters: RRC Radio Resource Control as defined in TS38.331 or Downlink Control Information DCI as defined in TS38.304 or LPP as defined in TS37.355

The complex correlation profile provides additional information on the correlation lob (area under a peak) or peak magnitude. In general a higher Bandwidth enables the measurement unit to better resolve the channel response on the FAP. For the phase processing a higher update rate is needed to accommodate the frequency offset and the movement. Hence the NW can configure one or more resources with a high periodicity and low bandwidth for phase processing and configuring a wide bandwidth with lower periodicity for other resources:
According to embodiments, the NW (gNB) can configure the UE to transmit multiple coherent resources:
   ◯ Configuring the UE with two or more resources with different configurations and indicating to the UE which resources should be coherently transmitted or processed.
   ◯ Configuring the UE with two or more resources with different configurations: where the configurations includes at least a bandwidth configuration or/and a period configuration and using both resource to determine a LOS condition.
      ■ For Phase processing: higher periodicity and/or low bandwidth
      ■ For TOA processing: Lower periodicity and/or higher bandwidth Determining a LOS/NLOS reception based on the phase measurements and track information.

In the presence of a movement profile along a track with unknown direction of movement and regular RS measurements (i.e., measurements made on periodic or semi-persistent RS along the track), for the determination of Δd (extra travelled distance between two successive measurements) two methods according to two embodiments can be distinguished.

### • Method 1: Information Obtained From Non-3GPP Extra Sensors

Motion information related to the movement profile of a mobile UE can be obtained upon LMF request. Such information include, terminal speed and orientation of UE, and distance traveled (i.e., displacement) between two successive RS measurements. The difference a radio wave is traveled after d m (i.e.,Δd) can then be calculated in the following steps:
o The distance traveled between two successive RS measurements d is estimated using internal sensors.

The UE orientation and the angle θ determined between the tracks points A, B and the TRP are determined using the Driving direction and Displacement information can also be estimated based on the information provided by internal sensors like IMU. The driving direction can be estimated with respect to a previous measurement point.

To enable this option, the LMF triggers the UE to report the Motion-Information (provided in LPP [1]) to a given time interval in relation to a transmitted SRS or a received PRS (or a reported measurement like RSTD). This LMF can request from the UE a startTime to associate the displacement information reported to the measurements used.
◯ The following equation is applied from basic geometry, Δd = d cosθ

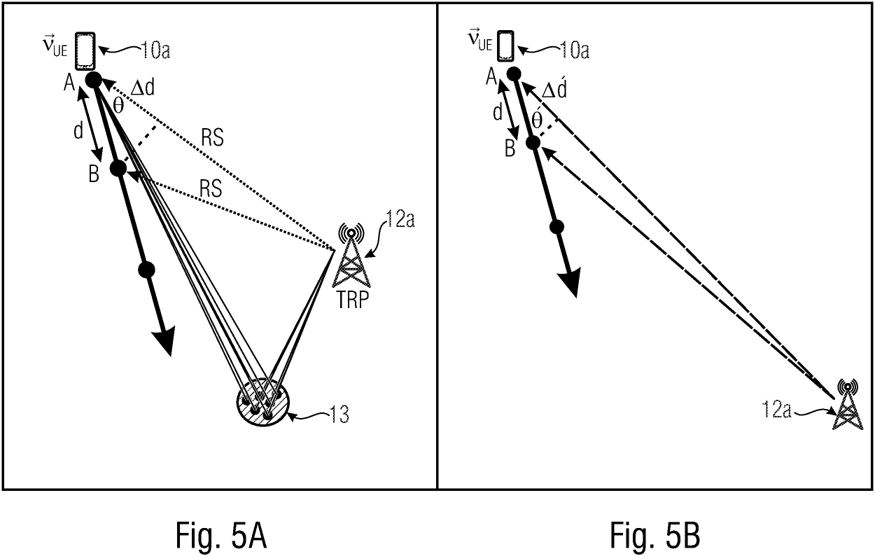

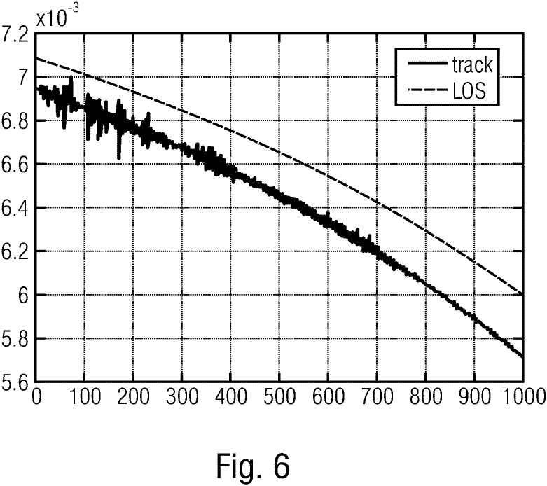

### • Method 2: Use Coherent RS Timestamps or TOA Estimates at Point A and Point B (see FIG. 5) in Order to Determine Δd.

FIG. 5a shows at UE 10 receiving a receive signal from a transmission point 12a. The UE 10a receives the receive signals RSs at point a and point b from the transmission point 12a.
◯ d is estimated as in Method 1.
◯ The UE measures two different RSs (for e.g. at point A and point B). The UE 10a can either use the timestamp available with the RSs or estimate RS TOA. Let timestamps or the TOA estimates of RSs at A and B be τ_{A}, and τ_{B} respectively, then
$$\text{Δ} d = c \left({τ}_{B} - {τ}_{A}\right) = c {\text{Δ}}_{τ} .$$

Once Δd is known, the phase difference between the two (coherent) radio signals received at point A and point B (i.e.,Δφ) is calculated using

$$\text{Δ} φ \text{=} \frac{2 π \text{Δ} d}{λ} + ε ,$$

where ε is a random error that account for frequency jitter. The phase difference is used to recognize state change (i.e., LOS/NLOS). In case the LOS path is blocked or obstructed, a NLOS scattering cluster (with multiple subpaths) can be considered as a virtual TRP 13 from the point of view of the UE as seen in FIGS. 5a, 5b. FIG. 5a illustrates the LOS situation, while FIG. 5b illustrates the NLOS situation.

Below, different approaches according to different embodiments will be used. For example, a procedure based on PLOS or multiple frequency bands, a downlink procedure, a downlink-uplink procedure or a sidelink procedure may be used. Below the basic steps for these procedures will be discussed, when it is clear that each procedure represents its own embodiment. Some of the steps discussed in the context of the procedures are marked as optional steps or as conditional steps.

### PRS on Multi-Frequency Bands (Coherent)

Assuming that coherence is maintained between two PRS resources (i.e., PRS are sent from the same TRP using the same local oscillator), then the UE can be indicated by the TRP that the two PRS are coherent. The UE uses this information to identify the phase difference between these two measurements. The relative phase difference with respect to two different measurements can be formulated as:

$$\text{Δ} {φ}_{1} = \frac{2 π Δ d}{{λ}_{1}} + f \left(t\right) + {ε}_{1}$$

$$\text{Δ} {φ}_{2} = \frac{2 π Δ d}{{λ}_{2}} + f \left(t\right) + {ε}_{2}$$

$$∇ \text{Δ} {φ}_{21} = 2 π Δ d \left(\frac{1}{{λ}_{2}} - \frac{1}{{λ}_{1}}\right) + {ε}_{21}$$

$${ε}_{21} = {ε}_{2} - {ε}_{1}$$

where f(t) is the frequency offset due to the oscillator impact and ε₁ and ε₂ are the a random errors that account for measurement noise at frequency 1 and 2.

According to embodiments, the NW (gNB) may configure the UE to transmit multiple coherent resources]
o Configuring the UE with two or more coherent resources with different frequencies and indicating to the UE which resources should be coherently transmitted or received.
o Configuring the UE with two or more coherent resources with different configurations: where the configurations are on different frequencies (inter-frequencies or Intra-frequencies)

### 5G Signaling Mechanism

### DL Procedure

1. NW checks UE capability for phase processing or channel state detection
2. Configure the UE to receive one or more PRS resource for phase processing or channel state detection
3. Provide UE with the PRS configuration and indicate resources to processed coherently
4. UE process the PRS resources and can:
   a. Report the phase measurements for multiple snapshots
   b. Report the Movement information w.r.t. the PRS measurements OR
   c. Report a LOS/NLOS/OLOS condition based on the PRS measurements within a TRP resource set

### UL Procedure

1. NW checks UE capability for phase transmission
2. Configure the UE with SRS for phase tracking configuration
   a. Indicate to the UE that SRS resource is configured for coherent processing. The UE may be configured not to drop an SRS transmission if configured for coherent processing when colliding with another signal according to the priority rules.
3. [optional] UE report the movement information w.r.t. the measurements
4. TRP process the SRS resources and can:
   a. Report the phase measurements to the LMF OR
   b. Report a LOS/NLOS/OLOS condition based on the SRS measurements within a SRS resource set
5. [conditional on 4.a] LMF detects the LOS/NLOS condition

### DL- UL Procedure (RTT)

1. NW checks UE capability for coherent SRS resource transmission NW checks UE capability for phase processing or channel state detection
2. Configure the UE with SRS for phase tracking configuration
   a. Indicate to the UE that SRS resource is configured for coherent processing. The UE may be configured not to drop an SRS transmission if configured for coherent processing when colliding with another signal according to the priority rules.
3. Configure the UE to receive one or more PRS resource for phase processing or channel state detection
4. Provide UE with the PRS configuration and indicate resources to processed coherently
5. [optional] UE report the Movement information w.r.t. the measurements
6. UE process the PRS resources and can:
   a. Report the phase measurements for multiple snapshots
   b. Report the Movement information w.r.t. the PRS measurements OR
   c. Report a LOS/NLOS/OLOS condition based on the PRS measurements within a TRP resource set
7. TRP process the SRS resources and can:
   a. Report the phase measurements to the LMF OR
   b. Report a LOS/NLOS/OLOS condition based on the SRS measurements within a SRS resource set
8. [conditional on 7.a] LMF detects the LOS/NLOS condition

### Sidelink Procedure (RTT)

1. NW checks UE(s) capability for coherent sidelink-PRS resource transmission NW checks UE(s) capability for phase processing or channel state detection
2. Configure the UE (or UEs) with sidelink-PRS for phase tracking configuration
   a. Indicate to the UE that sidelink-PRS resource is configured for coherent processing. A UE may be configured not to drop a sidelink-PRS transmission if configured for coherent processing when colliding with another signal according to the priority rules.
3. Configure the UE to receive one or more sidelink-PRS resource for phase processing or channel state detection
4. Provide UE with the sidelink-PRS configuration and indicate resources to processed coherently
5. [optional] One or multiple UEs reports the Movement information w.r.t. the measurements to
6. UE process the sidelink-PRS resources and can:
   a. Report the phase measurements for multiple snapshots
   b. Report the Movement information w.r.t. the PRS measurements OR
   c. Report a LOS/NLOS/OLOS condition based on the sidelink-PRS measurements within a second UE
7. [conditional on 6.a/b] LMF detects the LOS/NLOS condition

In order to enable the channel state analyzer to estimate the channel state, the channel analyzer may according to embodiments derive one or more channel parameters and compare these parameters with an expected function (such as a distribution function) or a value of this channel parameter, or a combination of multiple parameters. The expected function or value is dependent on channel state (LOS, NLOS and OLOS) and the measurement or reference channel. Examples on the measurement or reference channel can be Urban Micro, Urban Macro, Industry factory Dense, Industry factory sparse, indoor office open, indoor office mixed, outdoor to indoor, satellite open sky ...

In one embodiment, the channel analyzer receives from the network a message including information to enable estimating the channel state.

In a first option, the information message includes a channel model indication which the channel analyzer uses as a reference to derive one or more parameters for the channel state estimation. The information can include a channel model indication which in one example is an indication on known channel models such as the channel models (UMi, Uma, InH, InF-DH, InF-SH ... ) in TR 38.901. In another example the channel indication may represent a scenario-defined model which is known or pre-configured to the channel analyzer.

In a second option, the information message includes an one or values of the channel parameters associated with each channel state. In one example the values can be represented with a reference value or/and include values for the distribution function such as the mean, median and standard deviation.

The information message may include an indication of the channel model and one or more specific parameter values which, when signaled, overwrites the default parameter values of the channel model.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

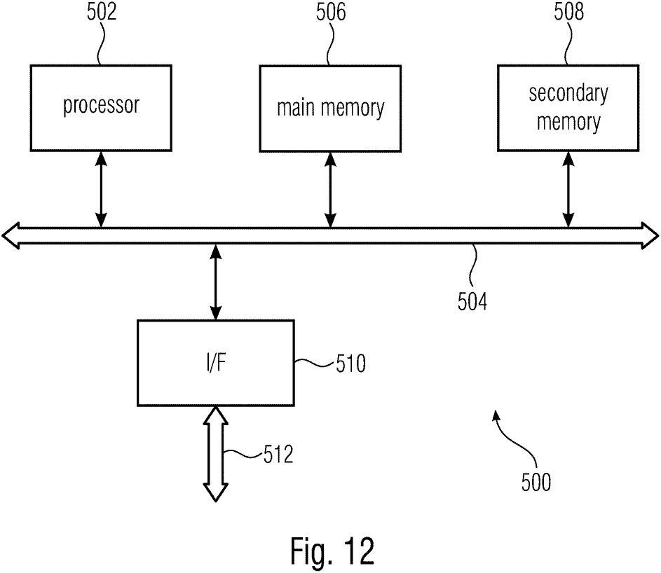

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES AND ABBREVIATIONS

| Reference Label (use Word bookmarks) | Details |
|---|---|
| [1] | 3GPP TS 37.355,” LTE Positioning Protocol (LPP)”, V16.1.0 |
| [2] | 3GPP TS 38.455,” NG-RAN; NR Positioning Protocol A (NRPPa),” V16.1.0 |
| [3] | 3GPP TS 38.331,” NR; Radio Resource Control (RRC); Protocol specification”, V16.1.0 |

| | |
|---|---|
| Abbreviation | Meaning |
| FAP | First Arriving Path |
| TOA | Time of Arrival |
| TRP | Transmission Reception Point |
| UE | User Equipment |
| gNB | Next Generation Node-B |
| RRC | Radio Resource Control |
| DCI | Downlink Control Information |
| LPP | LTE Positioning Protocol |
| IMU | Inertial measurement unit |
| OLOS | Obstructed Line Of Sight |
| LOS | Line Of Sight |
| NLOS | Non Line Of Sight |
| DL | Downlink |
| PRS | Positioning Reference Signal |
| RSTD | Reference Signal Time Difference |
| OTDoA | Observe Time Difference of Arrival |

1. Transceiver for receiving a receive signal or a plurality of receive signals to be used for position determination over multiple points of time, the transceiver comprising:
a measurement unit configured to perform a measurements to detect an information on a first arriving path, the information comprises a time or a direction for the first arriving path; and
a channel state analyzer configured to estimate a LOS channel condition to determine a channel state information describing the condition of the first arriving path.

2. The transceiver according to claim 1, wherein the channel state analyzer configured to analyze a correlation profile of the receive signal or the plurality of receive signals, wherein the analyzing comprises:
extraction of a first information for the correlation profile at a first point of time; and
extraction of a second information for the correlation profile at a second point of time; and
extraction of a third information for the correlation profile at a third point of time;
wherein the channel state analyzer is configured to determine the channel state information based on a relationship of the first, second and third information with respect to each other.

3. The transceiver according to claim 1, wherein the receive signal or the plurality of receive signals comprises multiple frames or is a periodic signal or a semi-persistent signal or a signal with a known time offset; and/or
wherein the channel state analyzer is configured to perform the evaluation for further points of time.

4. Transceiver according to claim 1, wherein the multi-points of time are defined by at least one out of the group comprising the following:
• a slot number
$${n}_{\text{s,f}}^{μ}$$
of a radio frame,
• a OFDM symbol number l, wherein l = 0 corresponds to the first OFDM symbol of the SRS or PRS transmission,
• a OFDM symbol index l′ of the slot that corresponds to the first OFDM symbol of the SRS transmission in the given slot.

5. Transceiver according to claim 1, wherein the receive signal or the plurality of receive signals is received along a movement of the transceiver for receiving the receive signal or the plurality of receive signals over the first, second and third point of time or along a movement of a transmitter outputting the receive signal or the plurality of receive signals over the first, second and third point of time.

6. The transceiver according to claim 1, wherein the channel state analyzer is configured to classify the receive signal or the plurality of receive signals as LOS state, NLOS state or to classify the receive signal or the plurality of receive signals as LOS state, NLOS state, OLOS state; and/or to classify the receive signal or the plurality of receive signals as LOS state, NLOS state or MPC state.

7. Transceiver according to claim 1, wherein the information to be extracted refers to at least one of the group comprising:
magnitude of the FAP peak;
width of a correlation lobe (near refractions causes the lobe to get wider and hence, effect the TOA quality);
characteristics of the cross correlation in complex plane;
overall channel information (RSPR, k-factor);
jitter of the FAP (time) position by comparing the expected TOA based on known resource configuration with the measured TOA;
phase information on multiple points of time (multiple time instances).

8. Transceiver according to claim 1, wherein the channel state analyzer is configured to perform a phase measurement of the receive signal or the plurality of receive signals received at the first point of time, second point of time and third point of time in order to extract the first, second and third information.

9. Transceiver according to claim 1, wherein the channel state analyzer is configured to perform a phase measurement to determine an angle of departure of a transmission signal and/or to determine an angle of arrival of the receive signal; and/or
wherein the channel state analyzer is configured to account the phase measurement with directional information derived from the Angle of Arrival and/or Angle of Departure and/or antenna beam characteristics; and/or
wherein the phase measurements comprise either one or a combination of the phase measurements on different time intervals, phase measurements at different frequencies or bandwidth parts, or phase measurements between different transmitter units or phase measurements between different receiver units or phase measurements between the different antenna ports of the same transmitter or receiver units.

10. Transceiver according to claim 9, wherein a proportional course of the phase measurement of the receive signal or the plurality of receive signals over the first, second and third point of time indicates to an LOS state; and/or
wherein a discontinuous course of the phase of the receive signal or the plurality of receive signals over the first, second and third point of time indicates an NLOS state; and/or
wherein a combination of a proportional course and a discontinuous course of a phase of the receive signal or the plurality of receive signals over the first, second and third point of time indicates an OLOS state.

11. Transceiver according to claim 1, wherein the channel state analyzer is configured to detect a first arriving path and/or a time-position of the first arriving path at a first, second and third point of time.

12. Transceiver according to claim 1, wherein the transceiver comprises a position determination entity configured to determine a position information based on an information regarding the first arriving path of the receive signal or the plurality of receive signals taking into account the channel state information.

13. Transceiver according to claim 1, wherein the transceiver comprises a reporting entity configured to output a report on the channel state information to a second transceiver; or
wherein the transceiver comprises a transmitter configured to output a report on the channel state information to a network entity (LMF) and wherein the report comprises an information out of the following:
channel state (LOS, NLOS, OLOS);
confidence information (an integer providing an indication of the confidence of the provided channel state information)
quality information (an integer providing an indication of the quality of the FAP of the receive signal or the plurality of receive signals);
second channel state;
second channel confidence information (second quality information);
occurrence (providing the percentage that a channel state occurred over a period of time;
LoS/NLoS indicator for DL, UL, and/or DL+UL positioning measurement.

14. Transceiver according to claim 1, wherein the channel state analyzer is configured to analyze the receive signal or the plurality of receive signals with regard to a confidence of the channel state and/or with regard to a quality of the receive signal or the plurality of receive signals; and/or
wherein a high amplitude and/or a sharp lobe indicates a high quality of the receive signal or the plurality of receive signals; and/or
wherein a low amount of information for the correlation profile out of a general trend of all information for the correlation profile indicates a high confidence of the channel state.

15. Transceiver according to claim 1, wherein the channel state information is used for the measuring out of the group;
RSTD for DL-TDOA and OTDOA;
RTT for multi-RTT;
RTOA of UL-TDOA;
DOA or AOA for directional based methods.

16. Transceiver according to claim 13, wherein the reporting entity is configured by a higher layer (RRC, LPP, NLPPA or DCI) to report a channel state.

17. Transceiver according to claim 1, wherein the channel state analyzer is configured to be triggered by a network entity or a base station, wherein the triggering comprises an exchange of the following information:
informing on capability for using channel state; and/or
requesting measurements of a channel state; and/or
configuring a transceiver to use the same Tx spatial filter during coherent processing.

18. Transceiver according to claim 1, wherein the channel state analyzer is configured to configure the transmitter transmitting the receive signal with one or more resources with different configurations, where the configurations are out the group comprising:
at least a bandwidth configuration (e.g high bandwidth in combination with low periodicity);
a period configuration (e.g high periodicity in combination with low bandwidth)
slot/offset and using both resource
to determine a LOS condition.

19. Transceiver according to claim 1, wherein the channel state analyzer is configured to configure the transmitter transmitting the receive signal with two or more resources and indicating which resources may be coherently processed; and/or
wherein the channel state analyzer is configured to configure the transmitter transmitting the receive signal comprising multiple signals or to receive the receive signal comprising multiple signals for a channel state detection mode with the same spatial domain transmission filter.

20. Transceiver according to claim 1, wherein the channel state analyzer is configured to trigger a transmission of a receive signal or the plurality of receive signals comprising at least two coherent signals (coherent bands).

21. The transceiver according to claim 1, wherein the channel state analyzer is configured to perform an analysis of a correlation profile with respect to a phase and amplitude.

22. The transceiver according to claim 1, wherein the channel state analyzer is configured to determine the LOS or NLOS channel state condition from a complex correlation at a measurement instant, comprising the substeps:
Detecting the time of arrival of a first arriving path within the measurement instant; and/or
Extracting at least three samples from the complex correlation values depending on the detected first arriving path; and/or
Evaluate the characteristics of the cross correlation in complex plane; and/or
Depending on the evaluation, estimate a LOS, OLOS or NLOS channel state for the FAP.

23. The transceiver according to claim 1, wherein he evaluation represents a complex correlation area; and/or
wherein the evaluation represents a difference between a reference complex correlation and a reference complex correlation; and/or
wherein the evaluation is performed on the more evaluation at multiple time instants.

24. The transceiver according to claim 1, wherein the transceiver receives a message comprising information on the one or more channel parameters, and
wherein the channel state analyzer is configured to determine the channel state information depending on the information message.

25. The transceiver according to claim 24, wherein the information on the one or more channel parameters comprises one or more of the following parameters:
Delay spread
Shadow fading
K-factor
AOD spread
AOA spread
ZOA spread
Cross-Correlations between two or more of the above parameters.

26. The transceiver according to claim 24, wherein the information on the one or more channel parameters comprises an indication on a channel model or an environment.

27. The transceiver according to claim 1, wherein the channel state analyzer is configured to derive one or more channel parameters and to compare the one or more channel parameters with an expected function or a value of the respective channel parameter, or a combination of multiple parameters; or
wherein the channel state analyzer is configured to derive one or more channel parameters and to compare the one or more channel parameters with an expected function or a value of the respective channel parameter, or a combination of multiple parameters or wherein an expected function or value of the respective channel parameter is dependent on channel state (LOS, NLOS and OLOS) and the measurement or reference channel.

28. The transceiver according to claim 1, wherein is configured to In one receive from a network, base station or transmission point (TRP) a message comprising information to enable estimating the channel state.

29. The transceiver according to claim 1 being part of a user equipment (downlink), or being part of TRPTRP (uplink) or being part of a user equipment (sidelink) communicating with another user equipment.

30. Transceiver according to claim 1, wherein the transceiver comprises a position/motion detection entity.

31. The transceiver according to claim 30, wherein the position/motion detection entity is configured to determine a motion of the transceiver and/or a direction of the motion of the transceiver using an internal sensor, advantageously an IMU sensor, or based on DL-PRS and/or UL-SRS and/or SL-PRS and/or CSI-RS and/or SSB.

32. The transceiver according to claim 30, wherein the position/motion detection entity is configured to determine the motion and/or direction upon LMF requests; and/or
wherein the LMF triggers the transceiver to report the motion / direction information to a given time interval in relation to a transmitted SRS or a received PRS; and/or
wherein the motion and/or direction information comprises a displacement information Δd.

33. The transceiver according to claim 30, wherein the position/motion detection energy is configured to determine a position at a first point of time and at a second point of time and to calculate the displacement Δd based on the equation Δd = c (τ_{B} - τ_{A}) = c Δ_{τ}.

34. The transceiver according to claim 33, wherein the channel state analyzer analyzes the channel state based on the formula using
$$\text{Δ} φ \text{=} \frac{2 π \text{Δ} d}{λ} + ε ,$$
wherein ε is a random error.

35. The transceiver according to claim 30, wherein the position/motion detection entity is configured to use MPC, in case of NLOS state (as virtual TRP from the point of view of the UE).

36. Communication system comprising at least a user equipment and a TRPTRP or at least two user equipments comprising a transceiver according to claim 20.

37. Communication system according claim 36, wherein the communication system comprises a network entity (LMF) configured the receive a report on the channel state information to from the transceiver of the user equipment and to determin a position of the user equipment based on the report;
wherein the report comprises an information out of the following:
channel state (LOS, NLOS, OLOS);
confidence information (an integer providing an indication of the confidence of the provided channel state information)
quality information (an integer providing an indication of the quality of the FAP of the receive signal or the plurality of receive signals);
second channel state;
second channel confidence information (second quality information);
occurrence (providing the percentage that a channel state occurred over a period of time;
LoS/NLoS indicator for DL, UL, and/or DL+UL positioning measurement.

38. Communication system according to claim 36, wherein one of the entities transmits the receive signal or the plurality of receive signals.

39. Method for signaling the LOS channel condition within a communication system according to claim 36, comprising (DL Procedure):
NW checks UE capability for phase processing or channel state detection;
Configure the UE to receive one or more PRS resource for phase processing or channel state detection;
Provide UE with the PRS configuration and/or indicate resources to process coherently;
UE process the PRS resources and/or report the phase measurements for multiple snapshots or the Movement information w.r.t the PRS measurements or a LOS/NLOS/OLOS condition based on the PRS measurements within a TRP resource set.

40. Method for signaling the LOS channel condition within a Communication system according to claim 36, comprising (UL Procedure):
NW checks UE capability for phase transmission;
Configure the UE with SRS for phase tracking configuration;
Indicate to the UE that SRS resource is configured for coherent processing;
UE report the movement information w.r.tthe measurements and/or TRP process the SRS resources and/or Report the phase measurements to the LMF and/or report a LOS/NLOS/OLOS condition based on the SRS measurements within a SRS resource set and/or LMF detects the LOS/NLOS condition.

41. Method for signaling the LOS channel condition within a Communication system according to claim 36, comprising (DL- UL Procedure (RTT)):
NW checks UE capability for coherent SRS resource transmission;
NW checks UE capability for phase processing or channel state detection
Configure the UE with SRS for phase tracking configuration;
Indicate to the UE that SRS resource is configured for coherent processing;
Configure the UE to receive one or more PRS resource for phase processing or channel state detection;
Provide UE with the PRS configuration and indicate resources to process coherently;
UE report the Movement information w.r.tthe measurements and/or UE process the PRS resources and/or Report the phase measurements for multiple snapshots and/or Report the Movement information w.r.t the PRS measurements and/or Report a LOS/NLOS/OLOS condition based on the PRS measurements within a TRP resource set and/or TRP process the SRS resources and/or Report the phase measurements to the LMF and/or Report a LOS/NLOS/OLOS condition based on the SRS measurements within a SRS resource set and/or LMF detects the LOS/NLOS condition.

42. Method for signaling the LOS channel condition within a Communication system according to claim 36, comprising (Sidelink Procedure (RTT)):
NW checks UE(s) capability for coherent sidelink-PRS resource transmission;
NW checks UE(s) capability for phase processing or channel state detection;
Configure the UE (or UEs) with sidelink-PRS for phase tracking configuration;
Indicate to the UE that sidelink-PRS resource is configured for coherent processing;
Configure the UE to receive one or more sidelink-PRS resource for phase processing or channel state detection;
Provide UE with the sidelink-PRS configuration and indicate resources to processed coherently;
One or multiple UEs reports the Movement information w.r.t the measurements and/or UE process the sidelink-PRS resources and/or Report the phase measurements for multiple snapshots and/or Report the Movement information w.r.t the PRS measurements and/or report a LOS/NLOS/OLOS condition based on the sidelink-PRS measurements within a second UE and/or LMF detects the LOS/NLOS condition.

43. A method for performing a channel state analysis comprising:
receiving a receive signal or the plurality of receive signals to be used for position determination over multiple points of time;
performing a measurements to detect an information on a first arriving path, advantageously a time or a direction for a first arriving path; and
estimating a LOS channel condition to determine a channel state information describing the condition of the FAP.

44. The method according to claim 43, wherein the estimating comprises an analyzing a correlation profile of a receive signal or the plurality of receive signals to be used for a position determination over multiple points of time, comprising the substeps of
extraction of a first information for the correlation profile at a first point of time; and
extraction of a second information for the correlation profile at a second point of time; and
extraction of a third information for the correlation profile at a third point of time; and
determining a channel state information describing the conditions of the receipt of the receive signal or the plurality of receive signals based on a relation of the first, second and third information with respect to each other.

45. A non-transitory digital storage medium having a computer program stored thereon to perform the method for performing a channel state analysis comprising:
receiving a receive signal or the plurality of receive signals to be used for position determination over multiple points of time;
performing a measurements to detect an information on a first arriving path, advantageously a time or a direction for a first arriving path; and
estimating a LOS channel condition to determine a channel state information describing the condition of the FAP,
when said computer program is run by a computer.

46. A transceiver configured to receive a receive signal and comprising a position/motion detection entity configured to determine a position/motion of the transceiver or a position/motion of another transceiver, wherein the position/motion detection entity uses for the determination of the position/motion a channel state information classifying the receive signal as LOS state, NLOS state, OLOS state, or MPC state.

47. The transceiver according to claim 46 being part of a user equipment (downlink), or being part of TRPS (uplink) or being part of a user equipment (sidelink) communicating with another user equipment.

48. Communication system comprising at least a user equipment and a TRP or at least two user equipments comprising a transceiver according to claim 47.

49. Method for position/motion detection, comprising:
receiving a receive signal and for a position/motion detection entity;
determining a position/motion of the transceiver or a position/motion of another transceiver by use of a channel state information classifying the receive signal as LOS state, NLOS state, OLOS state, or MPC state.

50. A non-transitory digital storage medium having a computer program stored thereon to perform the method for position/motion detection, comprising:
receiving a receive signal and for a position/motion detection entity;
determining a position/motion of the transceiver or a position/motion of another transceiver by use of a channel state information classifying the receive signal as LOS state, NLOS state, OLOS state, or MPC state,
when said computer program is run by a computer.
